(19) United States
(12) Patent Application Publication
(10) Pub. No.: US 2022/0320543 A1
(43) Pub. Date: Oct. 6, 2022

(54) ELECTRICAL POWER SYSTEM AND ELECTRICAL POWER CONTROL DEVICE

(71) Applicant: HONDA MOTOR CO., LTD., Tokyo (JP)

(72) Inventor: Nobutaka NAKAJIMA, Saitama (JP)

(21) Appl. No.: 17/692,175

(22) Filed: Mar. 11, 2022

(30) Foreign Application Priority Data
Mar. 30, 2021 (JP) 2021-058256

(51) Int. Cl. H01M 8/04537; H01M 8/04955; B60L 58/40

(52) U.S. Cl. CPC H01M 8/04619; H01M 8/04955; B60L 58/40; H01M 2250/20

(57) ABSTRACT

To provide an electrical power system and an electrical power control device that make it possible to improve fuel efficiency compared to that conventionally possible. An electrical power system according to an embodiment includes fuel cells at a count of n, n representing an integer of 2 or greater, and a controller. The fuel cells are each configured to generate electrical power through electrochemical reactions. The controller is configured to set, based on a required output required in accordance with electrical power to be consumed by a load, an operation mode for each of the fuel cells to one mode determined from a plurality of modes including a first electrical power generation mode under which starting and stopping of generation of electrical power are repeated, a second electrical power generation mode under which generation of electrical power continues, and a stop mode under which generation of electrical power is stopped.

This application is based on and claims the benefit of priority from Japanese Patent Application 2021-058256, filed on 30 Mar. 2021, the content of which is incorporated herein by reference.

### BACKGROUND OF THE INVENTION

### Field of the Invention

The present invention relates to an electrical power system and an electrical power control device.

### Related Art

There are motor vehicles each equipped with a plurality of fuel cells. In such a motor vehicle, a plurality of fuel cells are simultaneously operated.
Patent Document 1: Japanese Unexamined Patent Application (Translation of PCT Application), Publication No. 2011-503812

### SUMMARY OF THE INVENTION

However, when a plurality of fuel cells are operated simultaneously, the fuel efficiency becomes lower in an output region under a low load. One reason of this is that, when the fuel cells are operated under a low load, the efficiency becomes lower due to negative effects of a load of an auxiliary device.

An object of an embodiment of the present invention is to provide an electrical power system and an electrical power control device that make it possible to improve fuel efficiency compared to that conventionally possible.

An electrical power system according to an embodiment includes fuel cells at a count of n, n representing an integer of 2 or greater, and a controller. The fuel cells are each configured to generate electrical power through electrochemical reactions. The controller is configured to set, based on a required output required in accordance with electrical power to be consumed by a load, an operation mode for each of the fuel cells to one mode determined from a plurality of modes including a first electrical power generation mode under which starting and stopping of generation of electrical power are repeated, a second electrical power generation mode under which generation of electrical power continues, and a stop mode under which generation of electrical power is stopped.

The present invention makes it possible to improve fuel efficiency compared to that conventionally possible.

### BRIEF DESCRIPTION OF THE DRAWINGS

FIG. 1 is a block diagram illustrating an example of a main configuration of a motor vehicle according to an embodiment;

FIG. 2 is a flowchart illustrating an example of processing performed by a controller illustrated in FIG. 1;

FIG. 3 is a graph illustrating a relationship between outputs and efficiency of FCSs illustrated in FIG. 1;

FIG. 4 is a view illustrating an example of waveforms of the FCSs illustrated in FIG. 1; and

FIG. 5 is a graph illustrating a relationship between outputs and efficiency of the FCSs illustrated in FIG. 1.

### DETAILED DESCRIPTION OF THE INVENTION

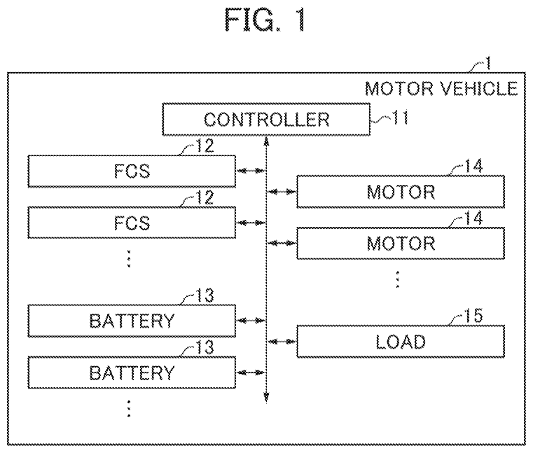

A motor vehicle according to an embodiment will now be described herein with reference to the accompanying drawings. Note that, in the drawings used to describe below the embodiment, there may be cases where the scale of each component is appropriately changed. Furthermore, in the drawings used to describe below the embodiment, some configurations may be omitted for the purpose of description. Furthermore, in the drawings and the specification, identical reference numerals represent similar or identical elements. FIG. 1 is a block diagram illustrating an example of a main configuration of a motor vehicle 1 according to the embodiment.

The motor vehicle 1 represents a motor vehicle that uses fuel cells as a driving power source for propelling (traveling), such as a fuel cell vehicle (FCV). The motor vehicle 1 includes, as an example, a controller 11, fuel cell systems (FCSs) 12, a battery 13, a motor 14, and a load 15. The motor vehicle 1 represents an example of an electrical power system.

The controller 11 represents, for example, a computer configured to perform processing such as calculations and controls necessary for operating the motor vehicle 1. The controller 11 controls each component to achieve various functions of the motor vehicle 1 based on programs, such as firmware, system software, and application software, stored in a main storage device or an auxiliary storage device, for example. Furthermore, the controller 11 executes processing described later based on the programs. Note that some or all of the programs may be incorporated into a circuit of the controller 11. The controller 11 represents an example of a load that consumes electrical power generated by the FCSs 12. The controller 11 represents an example of an electrical power control device.

The motor vehicle 1 includes a plurality of the FCSs 12. The FCSs 12 each include a fuel cell stack and various devices used to operate the fuel cell stack, for example. In the fuel cell stack, a plurality of fuel cells are stacked with each other. The fuel cell stack is configured to generate electrical power through electrochemical reactions of fuel gas and oxidant gas, for example, and to output the electrical power. The electrical power is supplied to each component of the motor vehicle 1, and is used to charge the battery 13 and to operate each component of the motor vehicle 1, such as to drive the motor 14. Furthermore, the FCSs 12 may each include, for example, an auxiliary device configured to supply fuel gas and oxidant gas to the fuel cell stack as a device for operating the fuel cell stack.

As for the battery 13, the motor vehicle 1 includes one battery 13 or a plurality of batteries 13. The battery 13 represents a secondary battery configured to supply electrical power to each component of the motor vehicle 1, such as the motor 14. That is, the motor vehicle 1 uses electrical power outputted from the FCSs 12 and electrical power outputted from the battery 13 to operate. The battery 13 is charged with the electrical power generated by the FCSs 12, for example.

As for the motor 14, the motor vehicle 1 includes one motor 14 or a plurality of motors 14. The motor 14 represents, for example, an electric device configured to convert inputted electrical power into a rotative force and to output the rotative force. The motor 14 uses electrical power that the FCSs 12 output and electrical power that the battery 13 outputs to operate. The rotative force that the motor 14 outputs rotates wheels and other components via gears and shafts, for example. The motor 14 represents an example of a load that consumes electrical power generated by the FCSs 12.

The load 15 represents, other than the controller 11 and the motor 14, a part that consumes electrical power generated by the FCSs 12. Examples of the load 15 include lighting devices, an air conditioner, on-vehicle devices, a monitor, a display, and a speaker.

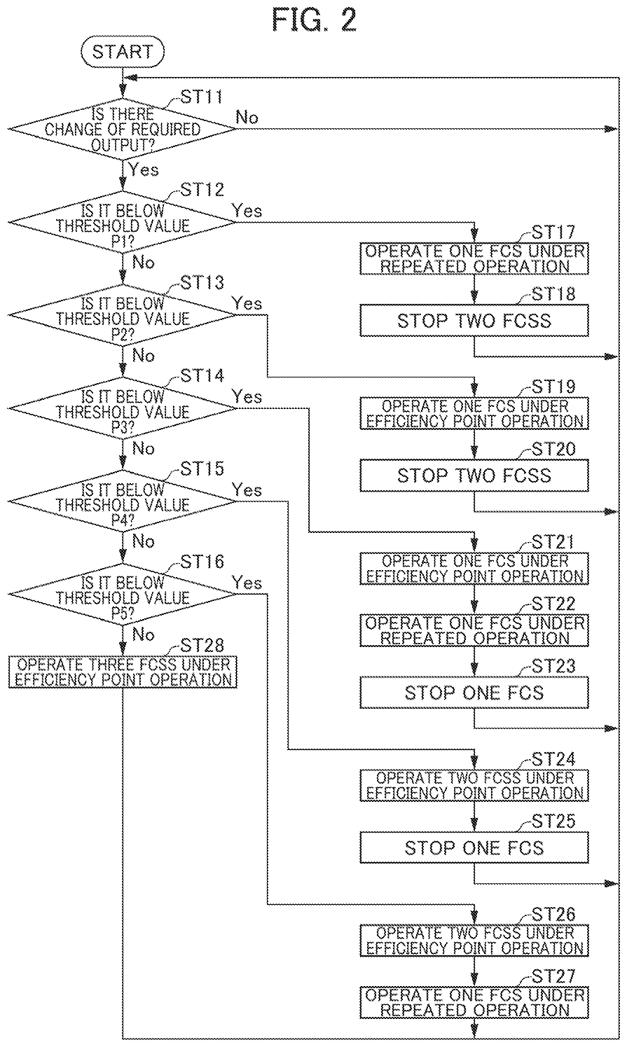

How the motor vehicle 1 according to the embodiment operates will now be described herein with reference to FIG. 2 and other drawings. Note that the content of the processing in the below operational description is a mere example. It is possible to appropriately utilize various types of processing that make it possible to acquire similar results. FIG. 2 is a flowchart illustrating an example of processing performed by the controller 11 of the motor vehicle 1. The controller 11 executes, for example, the processing illustrated in FIG. 2 based on the programs stored in a main storage device or an auxiliary storage device. Note that the processing illustrated in FIG. 2 represents processing when the motor vehicle 1 includes three FCSs 12.

At step ST11 illustrated in FIG. 2, the controller 11 waits for a change of a required output. The controller 11 performs control to allow a total output of output voltages of the FCSs 12 that the motor vehicle 1 includes to be equal to or above a required output. A required output changes depending on a state of the motor vehicle 1, for example. When the controller 11 has determined that there is a change of a required output, the controller 11 determines Yes at step ST11, and proceeds to step ST12.

At step ST12, the controller 11 determines whether the required output is below a threshold value P1. When the controller 11 has determined that the required output is equal to or above the threshold value P1, the controller 11 determines No at step ST12, and proceeds to step ST13. On the other hand, when the controller 11 has determined that the required output is below the threshold value P1, the controller 11 determines Yes at step ST12, and proceeds to step ST17.

At step ST13, the controller 11 determines whether the required output is below a threshold value P2. When the controller 11 has determined that the required output is equal to or above the threshold value P2, the controller 11 determines No at step ST13, and proceeds to step ST14. On the other hand, when the controller 11 has determined that the required output is below the threshold value P2, i.e., the required output is equal to or above P1 and below P2, the controller 11 determines Yes at step ST13, and proceeds to step ST19.

At step ST14, the controller 11 determines whether the required output is below a threshold value P3. When the controller 11 has determined that the required output is equal to or above the threshold value P3, the controller 11 determines No at step ST14, and proceeds to step ST15. On the other hand, when the controller 11 has determined that the required output is below the threshold value P3, i.e., the required output is equal to or above P2 and below P3, the controller 11 determines Yes at step ST14, and proceeds to step ST21.

At step ST15, the controller 11 determines whether the required output is below a threshold value P4. When the controller 11 has determined that the required output is equal to or above the threshold value P4, the controller 11 determines No at step ST15, and proceeds to step ST16. On the other hand, when the controller 11 has determined that the required output is below the threshold value P4, i.e., the required output is equal to or above P3 and below P4, the controller 11 determines Yes at step ST15, and proceeds to step ST24.

At step ST16, the controller 11 determines whether the required output is below a threshold value P5. When the controller 11 has determined that the required output is below the threshold value P5, i.e., the required output is equal to or above P4 and below P5, the controller 11 determines Yes at step ST16, and proceeds to step ST26. On the other hand, when the controller 11 has determined that the required output is equal to or above the threshold value P5, the controller 11 determines No at step ST16, and proceeds to step ST28.

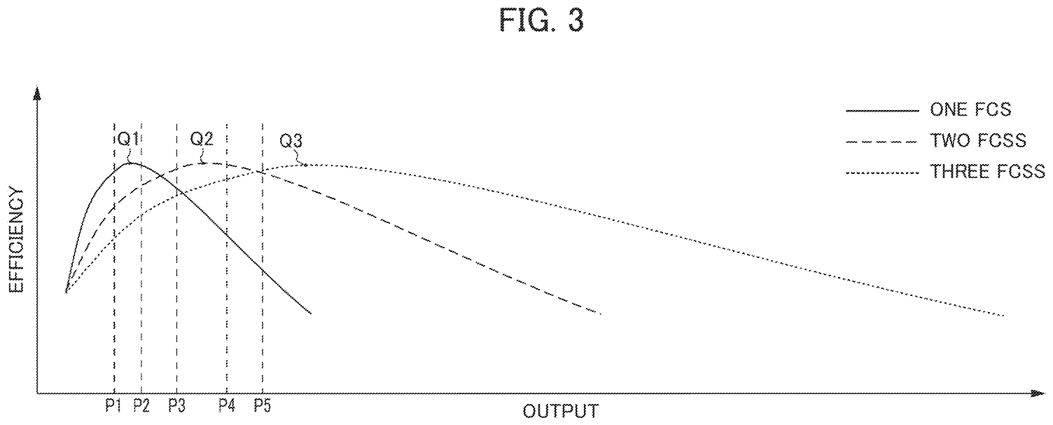

The threshold values will now be described with reference to FIG. 3. FIG. 3 is a graph illustrating a relationship between outputs and efficiency of the FCSs 12. FIG. 3 illustrates the graph illustrating respective output-efficiency characteristics when one to three of the FCSs 12 is or are operated. Furthermore, FIG. 3 illustrates a point Q1 representing a most efficient point when one of the FCS 12s is operated, a point Q2 representing a most efficient point when two of the FCSs 12 are operated, and a point Q3 representing a most efficient point when three of the FCSs 12 are operated. A magnitude relationship between the threshold value P1 to the threshold value P5 and outputs at the point Q1 to the point Q3 satisfies P1<Q1<P2<P3<Q2<P4<P5<Q3.

Note that an output at a point Qx represents a total output of the FCSs 12 at a count of x when the FCSs 12 at the count of x are most effectively operated. For example, when x=1, Qx is Q1. Furthermore, the output at the point Q1 represents an output of one of the FCSs 12 when the one of the FCSs 12 is most effectively operated. Note that x represents an integer equal to or above 1 and equal to or below n. n will be described later.

Furthermore, an output at a point P(2x−1) represents a value smaller, by a predetermined value, than an output at the point Qx, and an output at a point P(2x) represents a value greater, by a predetermined value, than the output at the point Qx. That is, the output at the point P1 represents a value smaller, by a predetermined value, than the output at the point Q1, and the output at the point P2 represents a value greater, by a predetermined value, than the output at the point Q1. Furthermore, the output at the point P3 represents a value smaller, by a predetermined value, than the output at the point Q2, and the output at the point P4 represents a value greater, by a predetermined value, than the output at the point Q2. Furthermore, the output at the point P5 represents a value smaller, by a predetermined value, than the output at the point Q3. Note that the predetermined values respectively may be different from or identical to each other.

As illustrated in FIG. 3, when a required output falls within a range from P1 to P2, it is conceivable that better efficiency is acquired when one of the FCSs 12 generates electrical power. Furthermore, when a required output falls within a range from P3 to P4, it is conceivable that better efficiency is acquired when two of the FCSs 12 generate electrical power. Furthermore, when a required output is equal to or above P5, it is conceivable that better efficiency is acquired when three of the FCSs 12 generate electrical power. Furthermore, when a required output is below P1, it is conceivable that better efficiency is acquired when one of the FCSs 12 generates electrical power with its output suppressed. Furthermore, when a required output falls within a range from P2 to P3, it is conceivable that better efficiency is acquired when two of the FCSs 12 generate electrical power with their outputs suppressed. Furthermore, when a required output falls within a range from P4 to P5, it is conceivable that better efficiency is acquired when three of the FCSs 12 generate electrical power with their outputs suppressed.

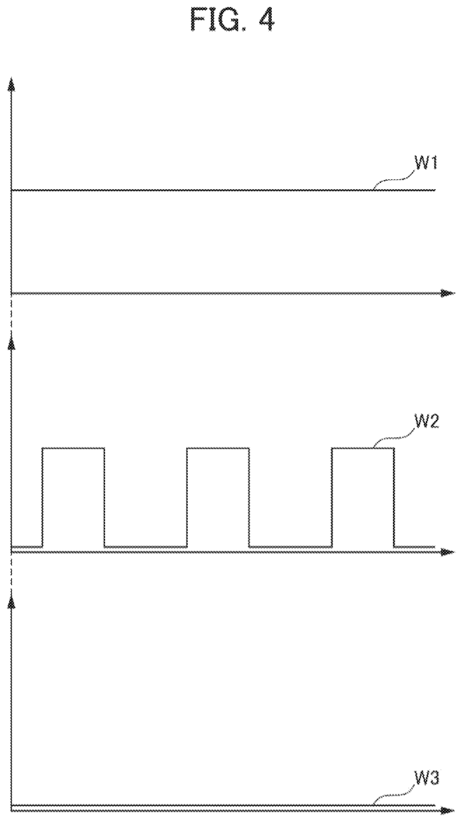

Now back to the description with reference to FIG. 2. At step ST17, the controller 11 causes one of the FCSs 12 to operate under a repeated operation. The repeated operation represents an operation where generation of electrical power is repeatedly turned on and off to suppress an output. In other words, the repeated operation represents an operation where starting and stopping of generation of electrical power are repeated to suppress an output. Note that a waveform W2 illustrated in FIG. 4 illustrates an example of a waveform in a state of the repeated operation. FIG. 4 is a view illustrating an example of waveforms of the FCSs 12. Note that the repeated operation represents an example of a first electrical power generation mode.

At step ST18 illustrated in FIG. 2, the controller 11 causes the remaining two of the FCSs 12 to stop generation of electrical power. Note that a waveform W3 illustrated in FIG. 4 illustrates an example of a waveform in a state where generation of electrical power is stopped. After step ST18 in the processing, the controller 11 returns to step ST11. Note that the state where generation of electrical power is stopped represents an example of a stop mode. With step ST17 and step ST18 in the processing illustrated in FIG. 2, one of the three FCSs 12 operates under the repeated operation, and two of the three FCSs 12 turn into the state where generation of electrical power is stopped.

At step ST19, the controller 11 causes one of the FCSs 12 to operate under an efficiency point operation. The efficiency point operation represents an operation where generation of electrical power continues at an output, the magnitude of which is greater than a predetermined magnitude, within a region where the electrical power generation efficiency is high. Note that the region where the electrical power generation efficiency is high represents, for example, a region where the efficiency is equal to or above a predetermined efficiency or a region where outputs of the FCSs 12 each fall within a predetermined range. Furthermore, an output when generation of electrical power is when power generation is on under the repeated operation is, for example, identical to or substantially identical to an output under the efficiency point operation. A waveform W1 illustrated in FIG. 4 illustrates an example of a waveform in a state of the efficiency point operation. Note that the efficiency point operation represents an example of a second electrical power generation mode. Furthermore, the first electrical power generation mode, the second electrical power generation mode, and the stop mode respectively represent example operation modes.

At step ST20, the controller 11 causes the remaining two of the FCSs 12 to stop generation of electrical power. After step ST20 in the processing, the controller 11 returns to step ST11. With step ST19 and step ST20 in the processing, one of the three FCSs 12 operates under the efficiency point operation, and two of the three FCSs 12 turn into the state where generation of electrical power is stopped.

At step ST21, the controller 11 causes one of the FCS 12 to operate under the efficiency point operation.

At step ST22, the controller 11 causes one FCS 12 of the remaining two FCSs 12 to operate under the repeated operation.

At step ST23, the controller 11 causes another one FCS 12 of the remaining two FCSs 12 to stop generation of electrical power. After step ST23 in the processing, the controller 11 returns to step ST11. With step ST21 to step ST23 in the processing, one of the three FCSS 12 operates under the efficiency point operation, another one of the three FCSs 12 operates under the repeated operation, and still another one of the three FCSs 12 turns into the state where generation of electrical power is stopped.

At step ST24, the controller 11 causes two of the FCSs 12 to operate under the efficiency point operation.

At step ST25, the controller 11 causes the remaining one of the FCSs 12 to stop generation of electrical power. After step ST25 in the processing, the controller 11 returns to step ST11. With step ST24 and step ST25 in the processing, two of the three FCSs 12 operate under the efficiency point operation and one of the three FCSs 12 turns into the state where generation of electrical power is stopped.

At step ST26, the controller 11 causes two of the FCSs 12 to operate under the efficiency point operation.

At step ST27, the controller 11 causes the remaining one of the FCSs 12 to operate under the repeated operation. After step ST27 in the processing, the controller 11 returns to step ST11. With step ST26 and step ST27 in the processing, two of the three FCSs 12 operate under the efficiency point operation and one of the three FCSs 12 operates under the repeated operation.

At step ST28, the controller 11 causes the three FCSs 12 to operate under the efficiency point operation. At step ST28 in the processing, the controller 11 returns to step ST11. Note that it is possible to use various methods where the controller 11 selects, at step S17 to step S27, which of the FCSs 12 is or are operated under the efficiency point operation, which of the FCSs 12 is or are operated under the repeated operation, and which of the FCSs 12 is or are caused to stop generation of electrical power. For example, the controller 11 causes one or more of the FCSs 12, which has or have been determined beforehand, one or more of the FCSs 12, which has or have been determined at random, one or more of the FCSs 12, which has or have been determined based on how long a period of operation time is or how much a degree of deterioration is, or one or more of the FCSs 12, which has or have been determined with another method, to operate under the efficiency point operation, to operate under the repeated operation, or to stop generation of electrical power. For example, the controller 11 causes, in a prioritized manner, one or more of the FCSs 12, which has or have a lower degree of deterioration, to operate under the efficiency point operation or the repeated operation.

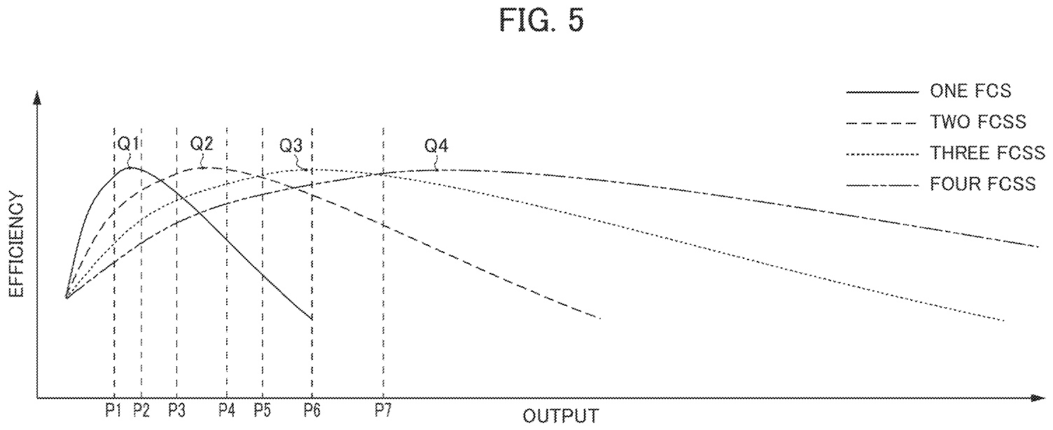

Furthermore, FIG. 5 illustrates an example when there are four FCSs 12. FIG. 5 is a graph illustrating a relationship between outputs and efficiency of the FCSs 12. FIG. 5 illustrates a graph illustrating respective output-efficiency characteristics when one to four of the FCSs 12 is or are operated. When there are four FCSs 12, the controller 11 uses, in addition to the threshold value P1 to the threshold value P5, a threshold value P6 and a threshold value P7 to control the FCSs 12. Furthermore, FIG. 5 illustrates, in addition to the point 01 to the point Q3, a point Q4 representing a most efficient point when the four FCSs 12 are operated. A magnitude relationship between the threshold value P1 to the threshold value P7 and outputs at the point Q1 to the point Q4 satisfies P1<Q1<P2<P3<Q2<P4<P5<Q3<P6<P7<Q4.

When there are four FCSs 12, and when a required output is below P5, the controller 11 controls the FCSs 12, similar to a case where there are three FCSs 12. However, when there are four FCSs 12, the number of FCSs 12 in the state where generation of electrical power is stopped is one more compared to a case where there are three FCSs 12. Furthermore, when a required output is equal to or above P5 and below P6, the controller 11 causes three of the FCSs 12 to operate under the efficiency point operation, and the remaining one of the FCSs 12 to turn into a state where its operation is stopped. Furthermore, when a required output is equal to or above P6 and below P7, the controller 11 causes three of the FCSs 12 to operate under the efficiency point operation, and the remaining one of the FCSs 12 to operate under the repeated operation. Furthermore, when a required output is equal to or above P7, the controller 11 causes the four FCSs 12 to operate under the efficiency point operation.

Furthermore, when there are the FCSs 12 at a count of n, and when a required output is equal to or above P(k−1) and below Pk, the controller 11 causes the FCSs 12 at a count of (floor(k/2)) to operate under the efficiency point operation, the FCSs 12 at a count of (k mod 2) to operate under the repeated operation, and the FCSs 12 at a count of (n−ceil(k/2)) to turn into the state where generation of electrical power is stopped. Furthermore, when a required output is below P1, one of the FCSs 12 is caused to operate under the repeated operation, and the FCSs 12 at a count of (n−1) are caused to turn into the state where generation of electrical power is stopped. Furthermore, when a required output is equal to or above P(k+1), the controller 11 causes the FCSs 12 at a count of n to operate under the efficiency point operation. Where, k represents an integer satisfying 2≤k≤(2n−1). Furthermore, floor represents a floor function, ceil represents a ceiling function, and mod represents a modulus operator. Furthermore, P(k−1) represents a (k−1)-th threshold value P, and Pk represents a k-th threshold value P. For example, when k=3, Pk represents a third threshold value P, i.e., the threshold value P3. Note that, when k represents an even number, P(k−1)<Q(k/2)<Pk is satisfied, and when k represents an odd number, Q((k−1)/2)<P(k−1)<Pk<Q((k+1)/2) is satisfied.

Furthermore, m represents an integer equal to or above 1 and equal to or below n. In this case, when a required output is equal to or above P(2m−2) and below P(2m−1), the controller 11 causes the FCSs 12 at a count of (m−1) to operate under the efficiency point operation, one of the FCSs 12 to operate under the repeated operation, and the FCSs 12 at a count of (n−m) to stop generation of electrical power. Furthermore, when a required output is equal to or above P(2m−1) and below P(2m), the controller 11 causes the FCSs 12 at a count of m to operate under the efficiency point operation, and the FCSs 12 at a count of (n−m) to stop generation of electrical power. However, when m=1, and when a required output is equal to or above 0 and below P(2m−1), the controller 11 causes one of the FCSs 12 to operate under the repeated operation, and the FCSs 12 at a count of (n−m) to stop generation of electrical power. Furthermore, when m=n, and when a required output is equal to or above P(2m−1), the controller 11 causes the FCSs 12 at a count of m to operate under the efficiency point operation. Note that an output at a point P(2m−1) has a value smaller, by a predetermined value, than an output at a point Qm, and an output at a point. P(2m) has a value greater, by a predetermined value, than the output at the point Qm. The predetermined values may be values that differ per the point P.

When 1≤m≤(n−1), a threshold value P(2m−1) represents an example of a threshold value A, and a threshold value P(2m) represents an example a threshold value B. As an example, when m=3, the threshold value P5 represents the threshold value A, and the threshold value P6 represents the threshold value B. Furthermore, a threshold value P(2n−1) represents an example of a threshold value C. As an example, when n=4, the threshold value P7 represents the threshold value C. Furthermore, the threshold value P1 represents an example of a first threshold value, the threshold value P2 represents an example of a second threshold value, and the threshold value P3 represents an example of a third threshold value.

The motor vehicle 1 according to the embodiment determines an operation mode for the FCSs 12 in accordance with a required output. Therefore, the motor vehicle 1 according to the embodiment makes it possible to generate electrical power at higher efficiency, compared with a case where the FCSs 12 at a count of n are operated with their outputs suppressed. Furthermore, the motor vehicle 1 according to the embodiment improves the fuel efficiency due to its higher efficiency.

Furthermore, the motor vehicle 1 according to the embodiment causes, when a required output is below P1, one of the FCSs 1 to operate under the repeated operation. Therefore, the motor vehicle 1 according to the embodiment makes it possible to generate electrical power at higher efficiency, compared with a case where the FCSs 12 at a count of n are operated with their outputs suppressed.

Furthermore, the motor vehicle 1 according to the embodiment causes, when a required output ranges from P1 to P2, one of the FCSs 1 to operate under the efficiency point operation. Therefore, the motor vehicle 1 according to the embodiment makes it possible to generate electrical power at higher efficiency, compared with a case where the FCSs 12 at a count of n are operated with their outputs suppressed.

Furthermore, the motor vehicle 1 according to the embodiment causes, when a required output ranges from P(2m−2) to P(2m−1), the FCSs 12 at a count of (m−1) to operate under the efficiency point operation, and one of the FCSs 12 to operate under the repeated operation. Therefore, the motor vehicle 1 according to the embodiment makes it possible to generate electrical power at higher efficiency, compared with a case where the FCSs 12 at a count of n are operated with their outputs suppressed.

Furthermore, the motor vehicle 1 according to the embodiment causes, when a required output ranges from P(2m−1) to P(2m), the FCSs 12 at a count of m to operate under the efficiency point operation. Therefore, the motor vehicle 1 according to the embodiment makes it possible to generate electrical power at higher efficiency, compared with a case where the FCSs 12 at a count of n are operated with their outputs suppressed.

Furthermore, the motor vehicle 1 according to the embodiment causes, when a required output is equal to or above P(2n−1), the FCSs 12 at a count of n to operate under the efficiency point operation. Therefore, the motor vehicle 1 according to the embodiment is no less efficient compared to conventional ones, even when high-output electrical power is required to be generated.

Furthermore, the motor vehicle 1 according to the embodiment causes FCSs 12 other than the FCSs 12 that are caused to operate under the efficiency point operation or the repeated operation to stop generation of electrical power. As described above, the motor vehicle 1 according to the embodiment makes it possible to generate electrical power at higher efficiency, compared with that conventionally possible, by causing one or more of the FCSs 12, which is or are not necessary for a required output to stop generation of electrical power.

Furthermore, the motor vehicle 1 according to the embodiment determines, based on a degree of deterioration, one or more of the FCSs 12, which is or are caused to operate under the efficiency point operation, and one or more of the FCSs 12, which is or are caused to operate under the repeated operation. Therefore, the motor vehicle 1 according to the embodiment makes it possible to shorten a period of time required to start the motor vehicle 1.

It is possible to modify the embodiment described above as described below. The controller 11 may determine outputs of the FCSs 12 in accordance with a state of charge of the battery 13. For example, when there is a small amount of charge remaining in the battery 13, the controller 11 controls timings for starting and stopping generation of electrical power to reduce a ratio of a period of time during which generation of electrical power is stopped in the repeated operation. The controller 11 then uses excess electrical power generated by the FCSs 12 to charge the battery 13.

An FCS may include a plurality of fuel cell stacks. The controller 11 may regard a pair of a plurality of FCSs 12 as one FCS, and control the one FCS. For example, it is assumed that the motor vehicle 1 includes six FCSs 12, i.e., FCS 12-1 to FCS 12-6. In this case, the controller 11 divides, as an example, the six FCSs 12 into three pairs, i.e., a pair including the FCS 12-1 and FCS 12-2, a pair including FCS 12-3 and FCS 12-4, and a pair including FCS 12-5 and FCS 12-6, and controls the three divided pairs. The controller 11 causes the FCSs 12 in a single pair to operate under an identical operation mode.

Such operation modes for the FCSs 12 may include modes other than the repeated operation, the efficiency point operation, and stopping of generation of electrical power.

The above embodiment has been described with reference to a motor vehicle as an example. However, it is possible to apply the electrical power system according to the embodiment to those other than motor vehicles, such as those vehicles or unattended machines that use fuel cells as a driving power source. For example, it is possible to apply the electrical power system according to the embodiment to airplanes, ships and vessels, submarines, or railroad vehicles that use fuel cells as a driving power source, for example. Furthermore, it is possible to apply the electrical power system according to the embodiment to machines other than vehicles and unattended machines, such as stationary systems including electrical power generation facilities and cogeneration systems, and robots.

The controller 11 may be one where a part or a whole of the processing achieved by the programs in the embodiment described above is achieved by a circuit hardware configuration.

The programs that achieve the processing according to the embodiment are transferred in a state where the programs are stored in a device, for example. However, the device may be transferred in a state where the programs are not stored. The programs may then be separately transferred, and written into the device. It is possible to achieve the transferring of the programs at this time in such a manner that the programs are recorded in a removable storage medium, or otherwise the programs are downloaded via a network such as the Internet or a local area network (LAN), for example.

Although the embodiment of the present invention has been described, the illustrated embodiment is a mere example and is not intended to limit the scope of the present invention. It is possible to implement the embodiment of the present invention in various aspects without departing from the gist of the present invention.

### EXPLANATION OF REFERENCE NUMERALS

1 MOTOR VEHICLE
11 CONTROLLER
12 FCS
13 BATTERY
14 MOTOR
15 LOAD

What is claimed is:

1. An electrical power system comprising:
fuel cells at a count of n each configured to generate electrical power through electrochemical reactions, n representing an integer of 2 or greater; and
a controller configured to set, based on a required output required in accordance with electrical power to be consumed by a load, an operation mode for each of the fuel cells to one mode determined from a plurality of modes including a first electrical power generation mode under which starting and stopping of generation of electrical power are repeated, a second electrical power generation mode under which generation of electrical power continues, and a stop mode under which generation of electrical power is stopped.

2. The electrical power system according to claim 1, wherein,
when the required output is equal to or above a threshold value A, the operation mode for the fuel cells at a count of m is set to the second electrical power generation mode,
when the required output is equal to or above a threshold value B, the operation mode for the fuel cells at the count of m is set to the second electrical power generation mode and the operation mode for one of the fuel cells is set to the first electrical power generation mode,
the threshold value A is smaller, by a predetermined value, than a total output of the fuel cells when each of the fuel cells at the count of m is most effectively operated,
the threshold value B is greater, by a predetermined value, than a total output of the fuel cells when each of the fuel cells at the count of m is most effectively operated, and
m represents an integer equal to or above 1 and equal to or below (n−1).

3. The electrical power system according to claim 1, wherein
the controller sets, when the required output is equal to or above a threshold value C, the operation mode for the fuel cells at the count of n to the second electrical power generation mode, and
the threshold value C is smaller, by a predetermined value, than a total output of output values of the fuel cells when each of the fuel cells at the count of n is most effectively operated.

4. The electrical power system according to claim 1, wherein,
when the required output is below a first threshold value, the operation mode for one of the fuel cells is set to the first electrical power generation mode,
when the required output is equal to or above the first threshold value and below a second threshold value, the operation mode for one of the fuel cells is set to the second electrical power generation mode,
when the required output is equal to or above the second threshold value and below a third threshold value, the operation mode for one of the fuel cells is set to the second electrical power generation mode and the operation mode for one of the fuel cells is set to the first electrical power generation mode,
the first threshold value is smaller, by a predetermined value, than an output of one of the fuel cells when the one of the fuel cells is most effectively operated,
the second threshold value is greater, by a predetermined value, than the output of the one of the fuel cells when the one of the fuel cells is most effectively operated, and
the third threshold value is greater than the second threshold value and smaller, by a predetermined value, than a total output of two of the fuel cells when the two of the fuel cells are most effectively operated.

5. The electrical power system according to claim 1, further comprising a secondary battery that is charged with electrical power generated by the fuel cells,
wherein the controller controls, in accordance with a state of charge of the secondary battery, timings for starting and stopping generation of electrical power under the first electrical power generation mode.

6. The electrical power system according to claim 1, wherein the controller determines to operate each of the fuel cells under the first electrical power generation mode or the second electrical power generation mode, based on a degree of deterioration of each of the fuel cells.

7. An electrical power control device comprising a controller configured to set, based on a required output required in accordance with electrical power to be consumed by a load, an operation mode for each of fuel cells at a count of n, n representing an integer of 2 or greater, each configured to generate electrical power through electrochemical reactions to one mode determined from a plurality of modes including a first electrical power generation mode under which starting and stopping of generation of electrical power are repeated, a second electrical power generation mode under which generation of electrical power continues, and a stop mode under which generation of electrical power is stopped.
